(19) United States
(12) Patent Application Publication
(10) Pub. No.: US 2021/0334826 A1
(43) Pub. Date: Oct. 28, 2021

(54) SYSTEMS AND METHODS FOR CALCULATING REACH WITH THE CONVERGENCE OF MULTIPLE PANEL UNIVERSES

(71) Applicant: GOOGLE LLC, Mountain View, CA (US)

(72) Inventors: Yunwen YANG, Mountain View, CA (US); Lu ZHANG, Mountain View, CA (US); James KOEHLER, Mountain View, CA (US); Xinyang SHEN, Mountain View, CA (US)

(21) Appl. No.: 16/322,472

(22) PCT Filed: May 31, 2018
(86) PCT No.: PCT/US2018/035406

§ 371 Date: Jan. 31, 2019

(51) Int. Cl. G06Q 30/02; H04L 29/08

(52) U.S. Cl. CPC G06Q 30/0201; H04L 67/22

(57) ABSTRACT

Systems, methods, and storage media for calculating a reach of a media item using a plurality of universes are disclosed. In some implementations, a method of calculating a reach comprises receive a first data set from a first cross media panel indicative of a number of times the media item was exposed to users having access to a first device type and one or more other device types including a second device type; determine a first reach using the first data set; receive a second data set from a second cross media panel indicative of a number of times the media item was exposed to users having access to a second device type and the one or more other device types including the first device type; determine a second reach using the second data set; receive a third data set from a first panel indicative of a number of times the media item was consumed by users on the first device type and the second device type; determine a third reach associated with the first device type and second device type from the third data set; estimate a first device type only reach using the first reach and the third reach; estimate a second device type only reach using the second reach and the third reach; and estimate the total reach.

### BACKGROUND

In cross media panels, the television and online usage of media content of individuals are measured and linked together on an individual level. For example, media content usage may be linked together by matching personal login IDs. Cross media (single-source) panels are used where data is gathered from a panel of users who own and use multiple devices as well as single-media panels where data is gathered from device types (e.g., televisions, mobile devices, desktop computers, and the like).

### SUMMARY

One aspect of the present disclosure relates to a system configured for calculating a total reach of a media item, the total reach indicating a total number of user exposures to the media item, using a plurality of panel universes, executed on a computing device. The system may include one or more processors configured by machine-readable instructions. The processor(s) may be configured to receive a first data set from a first cross media panel indicative of a number of times the media item was exposed to users having access to a first device type and one or more other device types including a second device type, wherein the users are exposed to the media item on at least one of the first device type or the one or more other device types. The processor(s) may be configured to determine a first reach using the first data set. The processor(s) may be configured to receive a second data set from a second cross media panel indicative of a number of times the media item was exposed to users having access to a second device type and the one or more other device types including the first device type. The users may be exposed to the media item on at least one of the second device type or the one or more other device types. The processor(s) may be configured to determine a second reach using the second data set. The processor(s) may be configured to receive a third data set from a first panel indicative of a number of times the media item was consumed by users on the first device type and the second device type. The processor(s) may be configured to determine a third reach associated with the first device type and second device type from the third data set. The processor(s) may be configured to estimate a first device type only reach using the first reach and the third reach. The first device type only reach may include the number of users having access to only the first device type who were exposed to the media content on the first device type. The processor(s) may be configured to estimate a second device type only reach using the second reach and the third reach. The second device type only reach may include the number of users having access to only the second device type who were exposed to the media content on the second device type. The processor(s) may be configured to estimate the total reach using the third reach, the first device type only reach, and the second device type only reach.

The first reach associated with the users having access to the first device type and the one or more other device types may be adjusted based on an assumption of invariance across the plurality of panel universes.

The adjustment may be by population difference between panel weightings and a population benchmark.

The second reach associated with the users having access to the second device type and the one or more other device types may be adjusted based on an assumption of invariance across the plurality of panel universes.

The adjustment may be by population difference between panel weightings and a population benchmark.

A joint reach of the first reach and the second reach may be invariant across the plurality of panel universes.

The one or more processors may be further configured by machine-readable instructions to compensate for a difference between populations of the plurality of panel universes by applying a scaling factor.

Another aspect of the present disclosure relates to a method for calculating a total reach of a media item, the total reach indicating a total number of user exposures to the media item, using a plurality of panel universes, executed on a computing device. The method may include receiving a first data set from a first cross media panel indicative of a number of times the media item was exposed to users having access to a first device type and one or more other device types including a second device type, wherein the users are exposed to the media item on at least one of the first device type or the one or more other device types. The method may include determining a first reach using the first data set. The method may include receiving a second data set from a second cross media panel indicative of a number of times the media item was exposed to users having access to a second device type and the one or more other device types including the first device type. The users exposed to the media item on at least one of the second device type or the one or more other device types. The method may include determining a second reach using the second data set. The method may include receiving a third data set from a first panel indicative of a number of times the media item was consumed by users on the first device type and the second device type. The method may include determining a third reach associated with the first device type and second device type from the third data set. The method may include estimating a first device type only reach using the first reach and the third reach. The first device type only reach may include the number of users having access to only the first device type who were exposed to the media content on the first device type. The method may include estimating a second device type only reach using the second reach and the third reach. The second device type only reach may include the number of users having access to only the second device type who were exposed to the media content on the second device type. The method may include estimating the total reach using the third reach, the first device type only reach, and the second device type only reach.

The first reach associated with the users having access to the first device type and the one or more other device types may be adjusted based on an assumption of invariance across the plurality of panel universes.

The adjustment may be by population difference between panel weightings and a population benchmark.

The second reach associated with the users having access to the second device type and the one or more other device types may be adjusted based on an assumption of invariance across the plurality of panel universes.

The adjustment may be by population difference between panel weightings and a population benchmark.

A joint reach of the first reach and the second reach may be invariant across the plurality of panel universes.

The method may further comprise compensating for a difference between populations of the plurality of panel universes by applying a scaling factor.

Another aspect of the present disclosure relates to a method of calculating a total reach of a media item, the total reach indicating a total number of user exposures to the media item, using a plurality of panel universes, executed on a computing device. The method comprises receiving a first data set from a cross media panel indicative of a number of times the media item was exposed to users having access to a plurality of device types, the users being exposed to the media item on at least one of the plurality of device types. The method may further comprise determining a first reach using the first data set, receiving a second data set from a first device type marginal panel indicative of a number of times the media item was consumed by users on a first device type of the plurality of device types, determining a second reach associated with the first device type from the second data set, receiving a third data set from a second device type marginal panel indicative of a number of times the media item was consumed by users on a second device type of the plurality of device types, determining a third reach associated with the second device type from the third data set, estimating a first device type only reach using the first reach and the second reach associated with the first device type, the first device type only reach comprising the number of users having access to only the first device type of the plurality of device types who were exposed to the media content on the first device type, estimating a second device type only reach using the first reach and the third reach associated with the second device type, the second device type only reach comprising the number of users having access to only the second device type of the plurality of device types who were exposed to the media content on the second device type, and estimating the total reach using the first reach, the first device type only reach, and the second device type only reach. The second reach associated with the users having access to the first device type may be adjusted based on an assumption of invariance across the plurality of panel universes.

The adjustment may be by population difference between panel weightings and a population benchmark.

The third reach associated with the users having access to the second device type may be adjusted based on an assumption of invariance across the plurality of panel universes.

The adjustment may be by population difference between panel weightings and a population benchmark.

The method may further comprise compensating for a difference between populations of the plurality of panel universes by applying a scaling factor.

Yet another aspect of the present disclosure relates to a non-transient computer-readable storage media having instructions embodied thereon, the instructions being executable by one or more processors to perform a method for calculating a total reach of a media item, the total reach indicating a total number of user exposures to the media item, using a plurality of panel universes, executed on a computing device. The method may include receiving a first data set from a first cross media panel indicative of a number of times the media item was exposed to users having access to a first device type and one or more other device types including a second device type. The users may be exposed to the media item on at least one of the first device type or the one or more other device types. The method may include determining a first reach using the first data set. The method may include receiving a second data set from a second cross media panel indicative of a number of times the media item was exposed to users having access to a second device type and the one or more other device types including the first device type. The users exposed to the media item on at least one of the second device type or the one or more other device types. The method may include determining a second reach using the second data set. The method may include receiving a third data set from a first panel indicative of a number of times the media item was consumed by users on the first device type and the second device type. The method may include determining a third reach associated with the first device type and second device type from the third data set. The method may include estimating a first device type only reach using the first reach and the third reach. The first device type only reach may include the number of users having access to only the first device type who were exposed to the media content on the first device type. The method may include estimating a second device type only reach using the second reach and the third reach. The second device type only reach may include the number of users having access to only the second device type who were exposed to the media content on the second device type. The method may include estimating the total reach using the third reach, the first device type only reach, and the second device type only reach.

Yet another aspect of the present disclosure relates to a system configured for calculating total reach with a plurality of panel universes. The system may include one or more processors configured by machine-readable instructions. The processor(s) may be configured to receive a plurality of data sets indicative of a reach of a plurality of devices. The processor(s) may be configured to determine a reach of television type devices of the plurality of devices. The processor(s) may be configured to determine a reach of online streaming content devices of the plurality of devices. The processor(s) may be configured to determine the total reach based on the reach of the television type devices and the online streaming content devices.

Yet another aspect of the present disclosure relates to a method for calculating total reach with a plurality of panel universes. The method may include receiving a plurality of data sets indicative of a reach of a plurality of devices. The method may include determining a reach of television type devices of the plurality of devices. The method may include determining a reach of online streaming content devices of the plurality of devices. The method may include determining the total reach based on the reach of the television type devices and the online streaming content devices.

Yet another aspect of the present disclosure relates to a non-transient computer-readable storage media having instructions embodied thereon, the instructions being executable by one or more processors to perform a method for calculating total reach with a plurality of panel universes. The method may include receiving a plurality of data sets indicative of a reach of a plurality of devices. The method may include determining a reach of television type devices of the plurality of devices. The method may include determining a reach of online streaming content devices of the plurality of devices. The method may include determining the total reach based on the reach of the television type devices and the online streaming content devices.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured for calculating a total reach of a media item using a plurality of panel universes in accordance with one or more implementations.

FIG. 2 illustrates a method for calculating total reach with a plurality of panel universes, in accordance with one or more implementations.

FIG. 3 illustrates a method for calculating a total reach of a media item, the total reach indicating a total number of user exposures to the media item in accordance with one or more implementations.

FIG. 4 illustrates another method for calculating a total reach of a media item, the total reach indicating a total number of user exposures to the media item in accordance with one or more implementations.

### DETAILED DESCRIPTION

Systems and methods are described for calculating a total reach of a media item using a plurality of panel universes in accordance with one or more implementations. The reach of a media item may include cross-media and/or extra reach of the item, for example an extra reach of YouTube™ video community in addition to existing television reach. Cross-media reach calculations may be used to plan and optimize campaigns. More specifically, the reach, extra reach, and/or total reach of online campaigns can be compared to more traditional campaigns such as television campaigns. Data may be obtained from groups and sub-groups with various differences that affect their usefulness as well as the accuracy of the data due to the type of group and quantity of members within the group. For example, some panel members may be part of a group reached through desktop-computer only while some panel members are reached through both desktop-computer and television.

In another example, some panel members are reached through mobile devices and television while other panel members are reached through desktop-computer and television. There are intersections in the groups depending on what media is being focused on. Reporting on a campaign can be accomplished by building a single-source panel that has panel members where all their devices as well as television are being measured. As a practical matter, panel members may be reluctant to measure consumption on more than one or two devices, but reach can be estimated using a cross-media panel along with individual device marginal panels.

Aspects and implementations of the disclosed subject matter provide a method of processing data from available panels associated with particular types of devices to generate additional data indicative of panels associated with other types of devices. This can be advantageous when panel data associated with the other types of devices is not otherwise accessible. That is, data relating to a particular device type can be inferred even in cases where the data relating to the device type cannot be directly accessed. Therefore, the subject matter of the present disclosure addresses technical problems associated with determining panel data from an incomplete set of panel data.

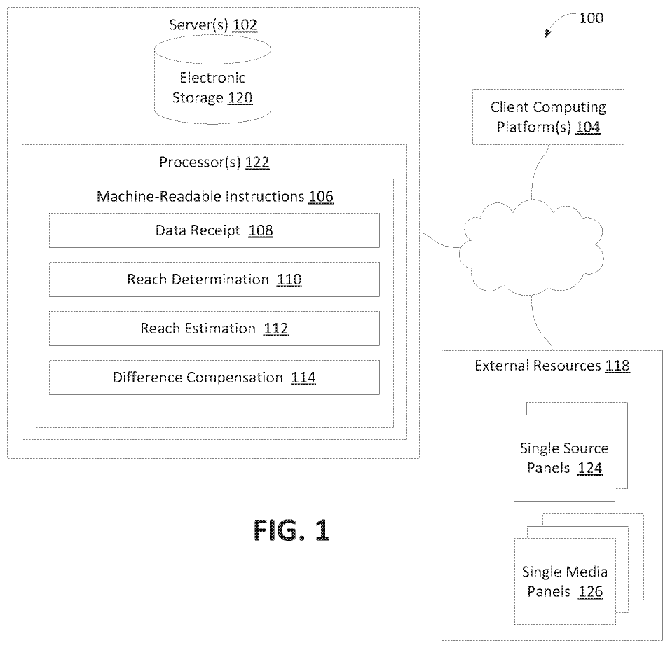

FIG. 1 illustrates a system 100 configured for calculating a total reach of a media item, the total reach indicating a total number of user exposures to the media item, using a plurality of panel universes, executed on a computing device, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104. In some implementations, system 100 may include external resources 118 including a plurality of panel universes comprising single source panels 124 and single media panels 126.

Server(s) 102 may be configured by machine-readable instructions 106.

Machine-readable instructions 106 may include one or more components. The instruction components may include computer program modules, computer circuits, system on a chip (SoC) components, and the like. The instruction components may include one or more of a data receipt 108, a reach determination 110, a reach estimation 112, a difference compensation 114, and/or other instruction components.

Data receipt 108 may be configured to receive a first data set from a first cross media panel indicative of a number of times the media item was exposed to users having access to a first device type and one or more other device types including a second device type. The users may be exposed to the media item on at least one of the first device type or the one or more other device types. A cross media panel may be a panel of users where the users own and use multiple device (e.g., television, mobile device, desktop, computer, and the like). In some implementations, the cross media panel is a single source panel where for each panelist, a number of exposures to a campaign is computed. In some implementations, a probability that the panelist is exposed to the media item is computed. In various implementations a cross media panel may be a panel of users comprising users that are exposed to a media item on one of a mobile device along with possible other devices, a desktop computer along with possible other devices, a desktop computer and a mobile device along with possible other devices, a mobile device and television along with possible other devices, a desktop computer and television along with possible other devices, a desktop computer and mobile device and television along with possible other devices, and the like.

Data receipt 108 may be configured to receive a second data set from a second cross media panel indicative of a number of times the media item was exposed to users having access to a second device type and the one or more other device types including the first device type. The users exposed to the media item on at least one of the second device type or the one or more other device types. In some implementations, the cross media panel is a single source panel where for each panelist, a number of exposures to a campaign is computed. In some implementations, a probability that the panelist is exposed to the media item is computed. In various implementations, a cross media panel may be a panel of users comprising users that are exposed to a media item on one of (1) a mobile device along with possible other devices, (2) a desktop computer along with possible other devices, (3) a desktop computer and a mobile device along with possible other devices, (4) a mobile device and television along with possible other devices, (5) a desktop computer and television along with possible other devices, (6) a desktop computer and mobile device and television along with possible other devices, and the like.

Data receipt 108 may be configured to receive a third data set from a first panel indicative of a number of times the media item was consumed by users on the first device type and the second device type. In some implementations, the panel (e.g., the first panel) is a single media panel where for each device type or for each one or more device types, a number of exposures to a campaign is computed for the device type or for the one or more device types. Device types may be desktop computers, laptop computers, mobile devices, televisions, and the like. In some implementations, a probability of number of exposures to the campaign is computed for the device type or for the one or more device types.

Reach determination 110 may be configured to determine a first reach using the first data set. In some implementations, the cross media panel is a single source panel where for each panelist, a reach (e.g., the first reach) is a number of exposures to a campaign. In some implementations, a probability that the panelist is exposed to the media item is computed. In some implementations, the first reach is a computation of a number of users with a threshold level of exposure on a device of the first device type. In various implementations a cross media panel may be a panel of users comprising users that are exposed to a media item on one of a mobile device along with possible other devices, a desktop computer along with possible other devices, a desktop computer and a mobile device along with possible other devices, a mobile device and television along with possible other devices, a desktop computer and television along with possible other devices, a desktop computer and mobile device and television along with possible other devices, and the like.

Reach determination 110 may be configured to determine a second reach using the second data set. In some implementations, the cross media panel is a single source panel where for each panelist, a reach (e.g., the second reach) is a number of exposures to a campaign. In some implementations, a probability that the panelist is exposed to the media item is computed. In some implementations, the first reach is a computation of a number of users with a threshold level of exposure on a device of the second device type. In various implementations a cross media panel may be a panel of users comprising users that are exposed to a media item on one of a mobile device along with possible other devices, a desktop computer along with possible other devices, a desktop computer and a mobile device along with possible other devices, a mobile device and television along with possible other devices, a desktop computer and television along with possible other devices, a desktop computer and mobile device and television along with possible other devices, and the like. A joint reach of the first reach and the second reach may be invariant across the plurality of panel universes.

Reach determination 110 may be configured to determine a third reach associated with the first device type and second device type from the third data set. In some implementations, the panel (e.g., the first panel) is a single media panel where for each device type or for each one or more device types, a reach of the respective device type is a number of exposures to a campaign for the respective device type or for the respective one or more device types. Device types may be desktop computers, laptop computers, mobile devices, televisions, and the like. In some implementations, the reach is a probability of number of exposures to the campaign computed for the device type or for the one or more device types.

Reach estimation 112 may be configured to estimate a first device type only reach using the first reach and the third reach. The first device type only reach may include the number of users having access to only the first device type who were exposed to the media content on the first device type. In some implementations, the first device type only reach is a subtraction of the third reach from the first reach. The third reach may be a number of exposures to a campaign of one or more device types (e.g., a desktop computer and a mobile device) or a probability of a number of exposures to the campaign computed for the device type or for the one or more device types. In some implementations, the third reach may be a number of users with a threshold level of exposure on a device of the first device type. A first reach may be, for each panelist, a computation of a number of exposures to a campaign, a computation of a probability that the panelist is exposed to the media item, or a computation of a number of users with a threshold level of exposure on a device of the first device type.

Reach estimation 112 may be configured to estimate a second device type only reach using the second reach and the third reach. The second device type only reach may include the number of users having access to only the second device type who were exposed to the media content on the second device type. In some implementations, the first device type only reach is a subtraction of the third reach from the second reach. The third reach may be a number of exposures to a campaign of one or more device types (e.g., a desktop computer and a mobile device) or a probability of a number of exposures to the campaign computed for the device type or for the one or more device types. In some implementations, the third reach may be a number of users with a threshold level of exposure on a device of the second device type. A first reach may be, for each panelist, a computation of a number of exposures to a campaign or a computation of a probability that the panelist is exposed to the media item, or a computation of a number of users with a threshold level of exposure on a device of the second device type.

The first reach associated with the users having access to the first device type and the one or more other device types may be adjusted based on an assumption of invariance across the plurality of panel universes. An invariant assumption may reduce potential inconsistency in extra reach calculation caused by data noise from cross-media panel universes. The assumption may be a postulate. The assumption may include a statement that is assumed to be true and from which a conclusion can be drawn, according to some implementations. Examples of the assumption may include one or more of condition, major premise, minor premise, scenario, thesis, and/or other assumptions. In some implementations, the assumption is made that the probability of being reached by an online streaming service is the same across different panel universes. In some implementations, the assumption is made that a device type reach is invariant across all universes of that device type (e.g., a desktop computer reach is invariant across all desktop universes, a mobile device reach is invariant across all mobile universes, and the like). In some implementations, a joint reach of a plurality of device types is invariant across all universes comprising the plurality of device types.

The second reach associated with the users having access to the second device type and the one or more other device types may be adjusted based on an assumption of invariance across the plurality of panel universes. The adjustment may be by population difference between panel weightings and a population benchmark.

Reach estimation 112 may be configured to estimate the total reach using one or more of the first reach, second reach, third reach, first device type only reach, and second device type only reach. In some implementations, a total reach may be a third reach comprising a number of users with a threshold level of exposure on a device of the first device type and a number of users with a threshold level of exposure on a device of the second device type added to the first device type only reach and to the second device type only reach. In some implementations, one or more of the first reach, second reach, third reach, first device type only reach, or second device type only reach is used to calculate an extra reach of the media content item which is added to a known reach of the media content item.

Reach estimation 112 may be configured to estimate the total reach using a limited set of panels. In some implementations, the panels may be limited to a set or subset of television panel, mobile device panel, desktop computer panel, desktop computer or mobile device panel, desktop computer or mobile device with television panel, where the users of the panel have access to at least the respective listed device(s). For example, an extra reach of a streaming service on a desktop computer may be determined by calculating a first number of users by subtracting a number of users that have access to (desktop computer or mobile device) and television with a threshold level of exposure to a media item on the desktop computer from a number of users that have access to (desktop computer or mobile device) with a threshold level of exposure to a media item on the desktop computer. Then, calculating a second number of users by subtracting a number of users that have access to (desktop computer or mobile device) and television with a threshold level of exposure to a media item on the television from a number of users that have access to (desktop computer or mobile device) and television with a threshold level of exposure to a media item on the desktop computer and television. Then calculating the extra reach by adding together the first number of users and the second number of users.

Difference compensation 114 may be configured to compensate for a difference between populations of the plurality of panel universes by applying a scaling factor. In some implementations, an invariant assumption cannot be applied to a reach of an electronic device directly without adjustment. In some implementations, an invariant assumption cannot be applied to a joint reach of a first device and a second device (e.g., an online streaming device and television) directly without adjustment. Instead, a set of scaling factors to each component of a panel universe (e.g., a television panel universe) can be applied to the respective reach. In some implementations, a scaling factor for a first device and second device universe can be calculated using a device panel universe population size and a population benchmark size for one of the devices (e.g., the first device). The scaling factor is used to compensate for the difference between panel based population size and the population benchmark.

In some implementations, server(s) 102, client computing platform(s) 104, and/or external resources 118 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 118 may be operatively linked via some other communication media.

A given client computing platform 104 may include one or more processors configured to execute computer program. The computer program may be configured to enable an expert or user associated with the given client computing platform 104 to interface with system 100 and/or external resources 118, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 118 may include sources of information outside of system 100, external entities participating with system 100, and/or other resources. In some implementations, some or all of the functionality attributed herein to external resources 118 may be provided by resources included in system 100. In some implementations, external resources 118 may include a plurality of panel universes comprising single source panels 124 and single media panels 126. A single source panel 124 may be comprised of panelists where the panelists (i.e., panel of users) are exposed to a media item on a plurality of electronic devices. For example, data from the single source panel provides data associated with the media item exposure of a mobile device along with other possible other devices of the same user or household. Other examples may include, a desktop computer along with possible other devices, a desktop computer and a mobile device along with possible other devices, a mobile device and television along with possible other devices, a desktop computer and television along with possible other devices, a desktop computer and mobile device and television along with possible other devices, and the like. A single media panel 126 may be comprised of panelists where the panelists are users of devices comprising one or more device types. Device types may be desktop computers, laptop computers, mobile devices, televisions, and the like. In some implementations, a single media panel is used that measures television reach. In some implementations, a single media panel is used that measures all online reach (not television reach).

Server(s) 102 may include electronic storage 120, one or more processors 122, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 120 may comprise non-transitory storage media that electronically stores information. The electronic storage media of electronic storage 120 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 120 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 120 may include one or more virtual storage resources (e.g., cloud storage, a virtual private network, and/or other virtual storage resources). Electronic storage 120 may store software algorithms, information determined by processor(s) 122, information received from server(s) 102, information received from client computing platform(s) 104, and/or other information that enables server(s) 102 to function as described herein.

Processor(s) 122 may be configured to provide information processing capabilities in server(s) 102. As such, processor(s) 122 may include one or more of a digital processor, an analog processor, a digital circuit designed to process information, an analog circuit designed to process information, a state machine, and/or other mechanisms for electronically processing information. Although processor(s) 122 is shown in FIG. 1 as a single entity, this is for illustrative purposes only. In some implementations, processor(s) 122 may include a plurality of processing units. These processing units may be physically located within the same device, or processor(s) 122 may represent processing functionality of a plurality of devices operating in coordination. Processor(s) 122 may be configured to execute components 108, 110, 112, 114, and/or other. Processor(s) 122 may be configured to execute components 108, 110, 112, 114, and/or other components by software; hardware; firmware; some combination of software, hardware, and/or firmware; and/or other mechanisms for configuring processing capabilities on processor(s) 122. As used herein, the term “component” may refer to any module, item, device, and the like, configured in software or hardware, that perform the functionality attributed to the component. This may include one or more physical processors during execution of processor readable instructions, the processor readable instructions, circuitry, hardware, storage media, or any other components.

It should be appreciated that although components 108, 110, 112, and 114 are illustrated in FIG. 1 as being implemented within a single processing unit, in implementations in which processor(s) 122 includes multiple processing units, one or more of components 108, 110, 112, and/or 114 may be implemented remotely from the other components. The description of the functionality provided by the different components 108, 110, 112, and/or 114 described below is for illustrative purposes, and is not intended to be limiting, as any of components 108, 110, 112, and/or 114 may provide more or less functionality than is described. For example, one or more of components 108, 110, 112, and/or 114 may be eliminated, and some or all of its functionality may be provided by other ones of components 108, 110, 112, and/or 114. As another example, processor(s) 122 may be configured to execute one or more additional components that may perform some or all of the functionality attributed below to one of components 108, 110, 112, and/or 114.

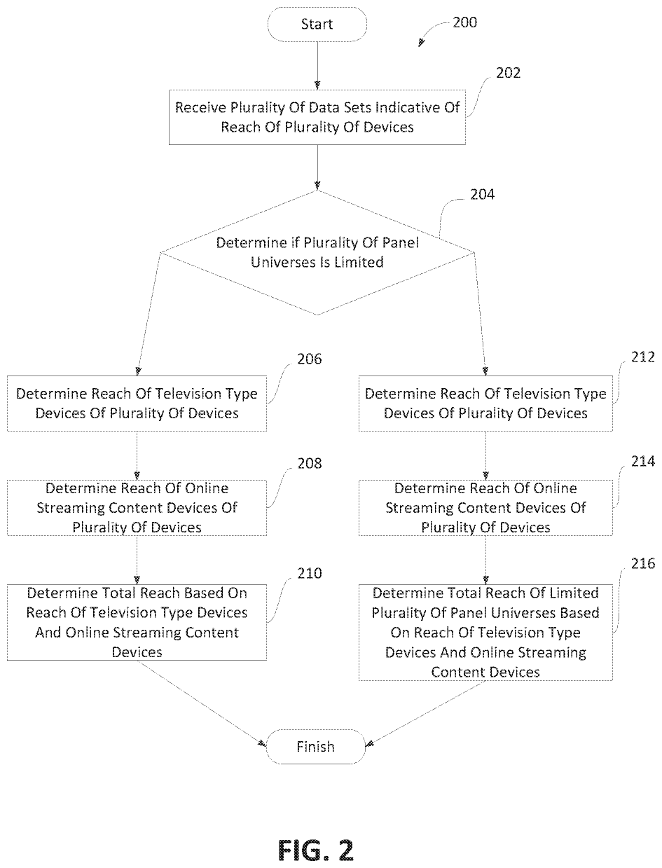

FIG. 2 illustrates a method 200 for calculating total reach with a plurality of panel universes, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage media. The one or more processing devices may include one or more devices configured through hardware, firmware, and/or software to be specifically designed for execution of one or more of the operations of method 200.

An operation 202 may include receiving a plurality of data sets indicative of a reach of a plurality of devices. Operation 202 may be performed by one or more processors configured by machine-readable instructions including a component that is the same as or similar to data receipt 108, in accordance with one or more implementations. In some implementations, a received data set may be a first data set from a first cross media panel indicative of a number of times the media item was exposed to users having access to a first device type and one or more other device types including a second device type. The users may be exposed to the media item on at least one of the first device type or the one or more other device types. In some implementations, the cross media panel is a single source panel where for each panelist, a number of exposures to a campaign is computed. In some implementations, a probability that the panelist is exposed to the media item is computed. In various implementations a cross media panel may be a panel of users comprising users that are exposed to a media item on one of a mobile device along with possible other devices, a desktop computer along with possible other devices, a desktop computer and a mobile device along with possible other devices, a mobile device and television along with possible other devices, a desktop computer and television along with possible other devices, a desktop computer and mobile device and television along with possible other devices, and the like.

An operation 204 may include determining if a plurality of panel universes is limited. In some implementations, the received plurality of data sets indicative of a reach of a plurality of devices is obtained from the plurality of panel universes. In some implementations, a limited plurality of panel universes comprising panels of users that are exposed to a media item on (1) a television along with possible other devices, (2) a mobile device along with possible other devices, (3) a desktop computer along with possible other devices, (3) a desktop computer or a mobile device along with possible other devices, and (4) (a desktop computer or a mobile device) and a television along possible other devices. In some implementations, a limited plurality of panel universes is another subset of all possible panel universes.

An operation 206 may include determining a reach of television type devices of the plurality of devices. Operation 206 may be performed by one or more processors configured by machine-readable instructions including a component that is the same as or similar to reach determination 110, in accordance with one or more implementations. In some implementations a reach of television type devices is determined using data from a single source panel where for each panelist, a reach is a number of exposures to a campaign. In some implementations, the reach is a computation of a number of users with a threshold level of exposure on a television device. In some implementations, the reach is a probability of number of exposures to the campaign computed for television type devices.

An operation 208 may include determining a reach of online streaming content devices of the plurality of devices. Operation 208 may be performed by one or more processors configured by machine-readable instructions including a component that is the same as or similar to reach determination 110, in accordance with one or more implementations. In some implementations a reach of one or more online streaming content device types is determined using data from one or more single source panels where for each panelist, a reach is a number of exposures to a campaign on the respective one or more online streaming content device types. In some implementations, the reach is a computation of a number of users with a threshold level of exposure on a respective online streaming content device type. In some implementations, the reach is a probability of number of exposures to the campaign computed for the respective online streaming content device type.

An operation 210 may include determining the total reach based on the reach of the television type devices and the online streaming content devices. Operation 210 may be performed by one or more processors configured by machine-readable instructions including a component that is the same as or similar to reach determination 110, in accordance with one or more implementations. In some implementations, a total reach is determined by calculating an extra reach of the online streaming content devices and adding to the reach of the television type devices.

An operation 212 may include determining a reach of television type devices of the plurality of devices. Operation 212 may be performed by one or more processors configured by machine-readable instructions including a component that is the same as or similar to reach estimation 112, in accordance with one or more implementations. In some implementations a reach of television type devices is determined using data from a single source panel where for each panelist, a reach is a number of exposures to a campaign. In some implementations, the reach is a computation of a number of users with a threshold level of exposure on a television device. In some implementations, the reach is a probability of number of exposures to the campaign computed for television type devices.

An operation 214 may include determining a reach of online streaming content devices of the plurality of devices. Operation 214 may be performed by one or more processors configured by machine-readable instructions including a component that is the same as or similar to reach estimation 112, in accordance with one or more implementations. In some implementations a reach of one or more online streaming content device types is determined using data from one or more single source panels where for each panelist, a reach is a number of exposures to a campaign on the respective one or more online streaming content device types. In some implementations, the reach is a computation of a number of users with a threshold level of exposure on a respective online streaming content device type. In some implementations, the reach is a probability of number of exposures to the campaign computed for the respective online streaming content device type.

An operation 216 may include determining the total reach of the limited plurality of panel universes based on the reach of the television type devices and the online streaming content devices. Operation 216 may be performed by one or more processors configured by machine-readable instructions including a component that is the same as or similar to reach estimation 112, in accordance with one or more implementations. In some implementations, a total reach is determined by calculating an extra reach of the online streaming content devices and adding to the reach of the television type devices.

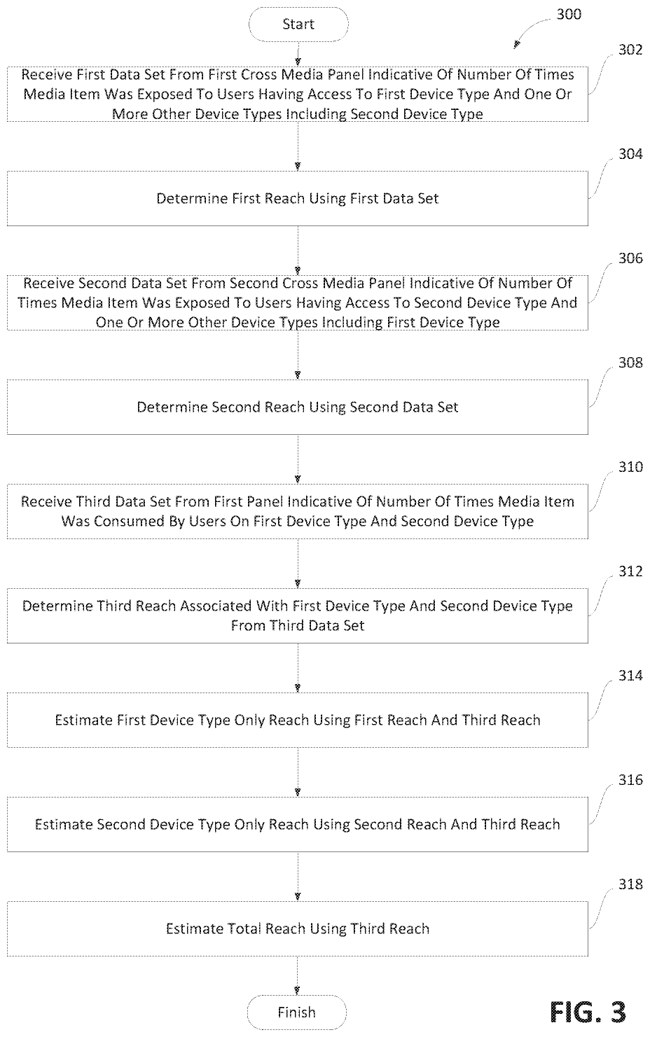

FIG. 3 illustrates a method 300 for calculating a total reach of a media item, the total reach indicating a total number of user exposures to the media item, using a plurality of panel universes, executed on a computing device, in accordance with one or more implementations. The operations of method 300 presented below are intended to be illustrative. In some implementations, method 300 may be accomplished with one or more additional operations not described, and/or without one or more of the operations discussed. Additionally, the order in which the operations of method 300 are illustrated in FIG. 3 and described below is not intended to be limiting.

In some implementations, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage media. The one or more processing devices may include one or more devices configured through hardware, firmware, and/or software to be specifically designed for execution of one or more of the operations of method 300.

An operation 302 may include receiving a first data set from a first cross media panel indicative of a number of times the media item was exposed to users having access to a first device type and one or more other device types including a second device type. The users are exposed to the media item on at least one of the first device type or the one or more other device types. Operation 302 may be performed by one or more processors configured by machine-readable instructions including a component that is the same as or similar to data receipt 108, in accordance with one or more implementations. A cross media panel may be a panel of users where the users own and use multiple device (e.g., television, mobile device, desktop, computer, and the like). In some implementations, the cross media panel is a single source panel where for each panelist, a number of exposures to a campaign is computed. In some implementations, a probability that the panelist is exposed to the media item is computed. In various implementations a cross media panel may be a panel of users comprising users that are exposed to a media item on one of (1) a mobile device along with possible other devices, (2) a desktop computer along with possible other devices, (3) a desktop computer and a mobile device along with possible other devices, (4) a mobile device and television along with possible other devices, (5) a desktop computer and television along with possible other devices, (6) a desktop computer and mobile device and television along with possible other devices, and the like.

An operation 304 may include determining a first reach using the first data set. Operation 304 may be performed by one or more processors configured by machine-readable instructions including a component that is the same as or similar to reach determination 110, in accordance with one or more implementations. In some implementations, the cross media panel is a single source panel where for each panelist, a reach (e.g., the first reach) is a number of exposures to a campaign. In some implementations, a probability that the panelist is exposed to the media item is computed. In some implementations, the first reach is a computation of a number of users with a threshold level of exposure on a device of the first device type. In various implementations a cross media panel may be a panel of users comprising users that are exposed to a media item on one of (1) a mobile device along with possible other devices, (2) a desktop computer along with possible other devices, (3) a desktop computer and a mobile device along with possible other devices, (4) a mobile device and television along with possible other devices, (5) a desktop computer and television along with possible other devices, (6) a desktop computer and mobile device and television along with possible other devices, and the like.

An operation 306 may include receiving a second data set from a second cross media panel indicative of a number of times the media item was exposed to users having access to a second device type and the one or more other device types including the first device type. The users exposed to the media item on at least one of the second device type or the one or more other device types. Operation 306 may be performed by one or more processors configured by machine-readable instructions including a component that is the same as or similar to data receipt 108, in accordance with one or more implementations. The users are exposed to the media item on at least one of the second device type or the one or more other device types. In some implementations, the cross media panel is a single source panel where for each panelist, a number of exposures to a campaign is computed. In some implementations, a probability that the panelist is exposed to the media item is computed. In various implementations, a cross media panel may be a panel of users comprising users that are exposed to a media item on one of (1) a mobile device along with possible other devices, (2) a desktop computer along with possible other devices, (3) a desktop computer and a mobile device along with possible other devices, (4) a mobile device and television along with possible other devices, (5) a desktop computer and television along with possible other devices, (6) a desktop computer and mobile device and television along with possible other devices, and the like.

An operation 308 may include determining a second reach using the second data set. Operation 308 may be performed by one or more processors configured by machine-readable instructions including a component that is the same as or similar to reach determination 110, in accordance with one or more implementations. In some implementations, the second data set is received from a cross media panel that is a single source panel where for each panelist, a reach (e.g., the second reach) is a number of exposures to a campaign. In some implementations, a probability that the panelist is exposed to the media item is computed. In some implementations, the first reach is a computation of a number of users with a threshold level of exposure on a device of the second device type. In various implementations a cross media panel may be a panel of users comprising users that are exposed to a media item on one of (1) a mobile device along with possible other devices, (2) a desktop computer along with possible other devices, (3) a desktop computer and a mobile device along with possible other devices, (4) a mobile device and television along with possible other devices, (5) a desktop computer and television along with possible other devices, (6) a desktop computer and mobile device and television along with possible other devices, and the like.

An operation 310 may include receiving a third data set from a first panel indicative of a number of times the media item was consumed by users on the first device type and the second device type. Operation 310 may be performed by one or more processors configured by machine-readable instructions including a component that is the same as or similar to data receipt 108, in accordance with one or more implementations. In some implementations, the third data set is received from a cross media panel that is a single source panel where for each panelist, a reach (e.g., the third reach) is a number of exposures to a campaign. In some implementations, a probability that the panelist is exposed to the media item is computed. In some implementations, the third reach is a computation of a number of users with a threshold level of exposure on a device of the first device type and of the second device type. Device types may be desktop computers, laptop computers, mobile devices, televisions, and the like. In some implementations, a probability of number of exposures to the campaign is computed for the device type or for the one or more device types.

An operation 312 may include determining a third reach associated with the first device type and second device type from the third data set. Operation 312 may be performed by one or more processors configured by machine-readable instructions including a component that is the same as or similar to reach determination 110, in accordance with one or more implementations. In some implementations, the cross media panel is a single source panel where for each panelist, a reach (e.g., the third reach) is a number of exposures to a campaign. In some implementations, a probability that the panelist is exposed to the media item is computed. In some implementations, the third reach is a computation of a number of users with a threshold level of exposure on a device of the first device type and on a device of the second device type. Device types may be desktop computers, laptop computers, mobile devices, televisions, and the like. In some implementations, a probability of number of exposures to the campaign is computed for the device type or for the one or more device types.

An operation 314 may include estimating a first device type only reach using the first reach and the third reach. The first device type only reach may include the number of users having access to only the first device type who were exposed to the media content on the first device type. Operation 314 may be performed by one or more processors configured by machine-readable instructions including a component that is the same as or similar to reach estimation 112, in accordance with one or more implementations. The first device type only reach may include the number of users having access to only the first device type who were exposed to the media content on the first device type. In some implementations, the first device type only reach is a subtraction of the third reach from the first reach. The third reach may be a number of exposures to a campaign of one or more device types (e.g., a desktop computer and a mobile device) or a probability of a number of exposures to the campaign computed for the device type or for the one or more device types. In some implementations, the third reach may be a number of users with a threshold level of exposure on a device of the first device type. A first reach may be, for each panelist, a computation of a number of exposures to a campaign, a computation of a probability that the panelist is exposed to the media item, or a computation of a number of users with a threshold level of exposure on a device of the first device type.

An operation 316 may include estimating a second device type only reach using the second reach and the third reach. The second device type only reach may include the number of users having access to only the second device type who were exposed to the media content on the second device type. Operation 316 may be performed by one or more processors configured by machine-readable instructions including a component that is the same as or similar to reach estimation 112, in accordance with one or more implementations. In some implementations, the first device type only reach is a subtraction of the third reach from the second reach. The third reach may be a number of exposures to a campaign of one or more device types (e.g., a desktop computer and a mobile device) or a probability of a number of exposures to the campaign computed for the device type or for the one or more device types. In some implementations, the third reach may be a number of users with a threshold level of exposure on a device of the second device type. A first reach may be, for each panelist, a computation of a number of exposures to a campaign or a computation of a probability that the panelist is exposed to the media item, or a computation of a number of users with a threshold level of exposure on a device of the second device type.

An operation 318 may include estimating the total reach using the third reach, the first device type only reach, and the second device type only reach. Operation 318 may be performed by one or more processors configured by machine-readable instructions including a component that is the same as or similar to reach estimation 112, in accordance with one or more implementations. In some implementations, a total reach may be a third reach comprising a number of users with a threshold level of exposure on a device of the first device type and a number of users with a threshold level of exposure on a device of the second device type added to the first device type only reach and to the second device type only reach. In some implementations, one or more of the first reach, second reach, third reach, first device type only reach, or second device type only reach is used to calculate an extra reach of the media content item which is added to a known reach of the media content item. In some implementations, the panels may be limited to a set or subset of television panel, mobile device panel, desktop computer panel, desktop computer or mobile device panel, desktop computer or mobile device with television panel, where the users of the panel have access to at least the respective listed device(s). For example, an extra reach of a streaming service on a desktop computer may be determined by calculating a first number of users by subtracting a number of users that have access to (desktop computer or mobile device) and television with a threshold level of exposure to a media item on the desktop computer from a number of users that have access to (desktop computer or mobile device) with a threshold level of exposure to a media item on the desktop computer. Then, calculating a second number of users by subtracting a number of users that have access to (desktop computer or mobile device) and television with a threshold level of exposure to a media item on the television from a number of users that have access to (desktop computer or mobile device) and television with a threshold level of exposure to a media item on the desktop computer and television. Then calculating the extra reach by adding together the first number of users and the second number of users.

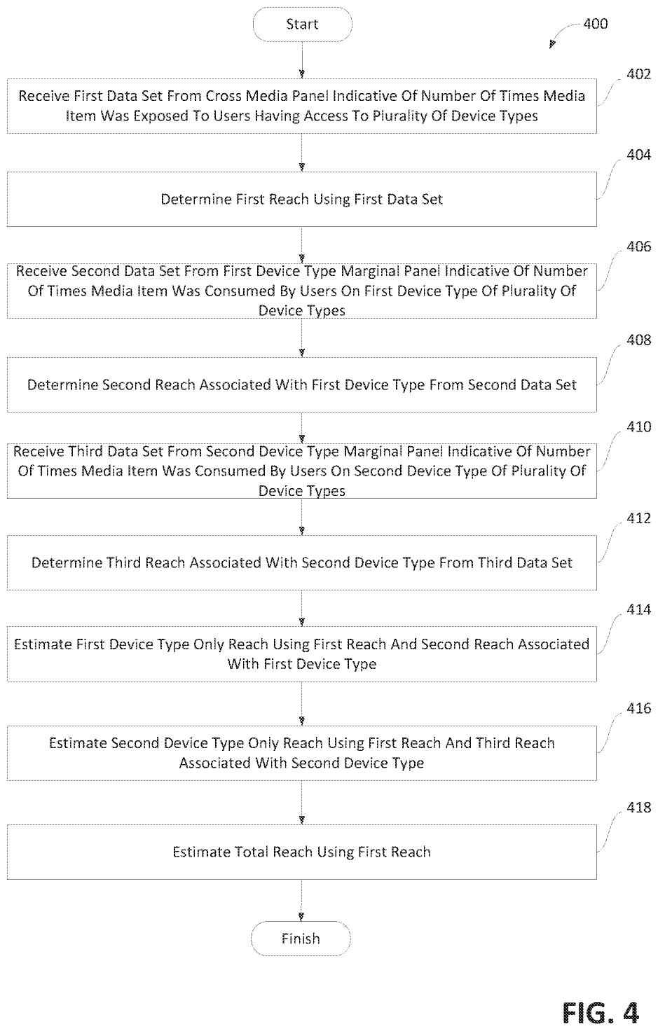

FIG. 4 illustrates a method 400 for calculating a total reach of a media item, the total reach indicating a total number of user exposures to the media item, using a plurality of panel universes, executed on a computing device, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage media. The one or more processing devices may include one or more devices configured through hardware, firmware, and/or software to be specifically designed for execution of one or more of the operations of method 400.

An operation 402 may include receiving a first data set from a cross media panel indicative of a number of times the media item was exposed to users having access to a plurality of device types. The users may be exposed to the media item on at least one of the plurality of device types. Operation 402 may be performed by one or more processors configured by machine-readable instructions including a component that is the same as or similar to data receipt 108, in accordance with one or more implementations. A cross media panel may be a panel of users where the users own and use multiple devices (e.g., television, mobile device, desktop, computer, and the like). In some implementations, the cross media panel is a single source panel where for each panelist, a number of exposures to a campaign is computed. In some implementations, a probability that the panelist is exposed to the media item is computed.

An operation 404 may include determining a first reach using the first data set. Operation 404 may be performed by one or more processors configured by machine-readable instructions including a component that is the same as or similar to reach determination 110, in accordance with one or more implementations. In some implementations, the first reach is a computation of a number of users with a threshold level of exposure. In various implementations a cross media panel may be a panel of users comprising users that are exposed to a media item on one of a mobile device along with possible other devices, a desktop computer along with possible other devices, a desktop computer and a mobile device along with possible other devices, a mobile device and television along with possible other devices, a desktop computer and television along with possible other devices, a desktop computer and mobile device and television along with possible other devices, and other like combinations.

An operation 406 may include receiving a second data set from a first device type marginal panel indicative of a number of times the media item was consumed by users on a first device type of the plurality of device types. Operation 406 may be performed by one or more processors configured by machine-readable instructions including a component that is the same as or similar to data receipt 108, in accordance with one or more implementations. A first device type marginal panel may be a panel of users where the users own and use one or more devices (e.g., television, mobile device, desktop, computer, and the like). In some implementations, the first device type marginal panel is a single source panel where for each panelist, a number of exposures to a campaign is computed on the first device type of the plurality of device types. In some implementations, a probability that the panelist is exposed to the media item on the first device type is computed.

An operation 408 may include determining a second reach associated with the first device type from the second data set. Operation 408 may be performed by one or more processors configured by machine-readable instructions including a component that is the same as or similar to reach determination 110, in accordance with one or more implementations. In some implementations, the first device type marginal panel is a single source panel where for each panelist, a reach (e.g., the second reach) is a number of exposures to a campaign on the first device type. In some implementations, a probability that the panelist is exposed to the media item on the first device type is computed. In some implementations, the first reach is a computation of a number of users with a threshold level of exposure on a device of the first device type.

An operation 410 may include receiving a third data set from a second device type marginal panel indicative of a number of times the media item was consumed by users on a second device type of the plurality of device types. Operation 410 may be performed by one or more processors configured by machine-readable instructions including a component that is the same as or similar to data receipt 108, in accordance with one or more implementations. A second device type marginal panel may be a panel of users where the users own and use one or more devices (e.g., television, mobile device, desktop, computer, and the like). In some implementations, the second device type marginal panel is a single source panel where for each panelist, a number of exposures to a campaign is computed on the second device type of the plurality of device types. In some implementations, a probability that the panelist is exposed to the media item on the second device type is computed.

An operation 412 may include determining a third reach associated with the second device type from the third data set. Operation 412 may be performed by one or more processors configured by machine-readable instructions including a component that is the same as or similar to reach determination 110, in accordance with one or more implementations. In some implementations, the second device type marginal panel is a single source panel where for each panelist, a reach (e.g., the third reach) is a number of exposures to a campaign on the second device type. In some implementations, a probability that the panelist is exposed to the media item on the second device type is computed. In some implementations, the first reach is a computation of a number of users with a threshold level of exposure on a device of the second device type.

An operation 414 may include estimating a first device type only reach using the first reach and the second reach associated with the first device type. The first device type only reach may include the number of users having access to only the first device type of the plurality of device types who were exposed to the media content on the first device type. Operation 414 may be performed by one or more processors configured by machine-readable instructions including a component that is the same as or similar to device type estimating 112, in accordance with one or more implementations. The first device type only reach may include the number of users having access to only the first device type who were exposed to the media content on the first device type. In some implementations, the first device type only reach is a subtraction of the third reach from the first reach associated with the first device type.

An operation 416 may include estimating a second device type only reach using the first reach and the third reach associated with the second device type. The second device type only reach may include the number of users having access to only the second device type of the plurality of device types who were exposed to the media content on the second device type. Operation 416 may be performed by one or more processors configured by machine-readable instructions including a component that is the same as or similar to device type estimating 112, in accordance with one or more implementations. The second device type only reach may include the number of users having access to only the second device type who were exposed to the media content on the second device type. In some implementations, the second device type only reach is a subtraction of the third reach from the first reach associated with the second device type.

An operation 418 may include estimating the total reach using the first reach, the first device type only reach, and the second device type only reach. Operation 418 may be performed by one or more processors configured by machine-readable instructions including a component that is the same as or similar to reach estimation 112, in accordance with one or more implementations. In some implementations, a total reach may be a first reach comprising a number of users with a threshold level of exposure on a device of the first device type and a number of users with a threshold level of exposure on a device of the second device type added to the first device type only reach and to the second device type only reach. In some implementations, one or more of the first reach, second reach, third reach, first device type only reach, or second device type only reach is used to calculate an extra reach of the media content item which is added to a known reach of the media content item.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured for calculating a total reach of a media item, the total reach indicating a total number of user exposures to the media item, using a plurality of panel universes, executed on a computing device, the system comprising:
one or more processors configured by machine-readable instructions to:
receive a first data set from a first cross media panel indicative of a number of times the media item was exposed to users having access to a first device type and one or more other device types including a second device type, the users exposed to the media item on at least one of the first device type or the one or more other device types;
determine a first reach using the first data set;
receive a second data set from a second cross media panel indicative of a number of times the media item was exposed to users having access to a second device type and the one or more other device types including the first device type, the users exposed to the media item on at least one of the second device type or the one or more other device types;
determine a second reach using the second data set;
receive a third data set from a first panel indicative of a number of times the media item was consumed by users on the first device type and the second device type;
determine a third reach associated with the first device type and second device type from the third data set;
estimate a first device type only reach using the first reach and the third reach, the first device type only reach comprising the number of users having access to only the first device type who were exposed to the media content on the first device type;
estimate a second device type only reach using the second reach and the third reach, the second device type only reach comprising the number of users having access to only the second device type who were exposed to the media content on the second device type; and
estimate the total reach using the third reach, the first device type only reach, and the second device type only reach.

2. The system of claim 1, wherein the first reach associated with the users having access to the first device type and the one or more other device types is adjusted based on an assumption of invariance across the plurality of panel universes.

3. The system of claim 2, wherein the adjustment is by population difference between panel weightings and a population benchmark.

4. The system of claim 1, wherein the second reach associated with the users having access to the second device type and the one or more other device types is adjusted based on an assumption of invariance across the plurality of panel universes.

5. The system of claim 4, wherein the adjustment is by population difference between panel weightings and a population benchmark.

6. The system of claim 1, wherein a joint reach of the first reach and the second reach is invariant across the plurality of panel universes.

7. The system of claim 1, wherein the one or more processors are further configured by machine-readable instructions to compensate for a difference between populations of the plurality of panel universes by applying a scaling factor.

8. A method of calculating a total reach of a media item, the total reach indicating a total number of user exposures to the media item, using a plurality of panel universes, executed on a computing device, the method comprising:
receiving a first data set from a first cross media panel indicative of a number of times the media item was exposed to users having access to a first device type and one or more other device types including a second device type, the users exposed to the media item on at least one of the first device type or the one or more other device types;
determining a first reach using the first data set;
receiving a second data set from a second cross media panel indicative of a number of times the media item was exposed to users having access to a second device type and the one or more other device types including the first device type, the users exposed to the media item on at least one of the second device type or the one or more other device types;
determining a second reach using the second data set;
receiving a third data set from a first panel indicative of a number of times the media item was consumed by users on the first device type and the second device type;
determining a third reach associated with the first device type and second device type from the third data set;
estimating a first device type only reach using the first reach and the third reach, the first device type only reach comprising the number of users having access to only the first device type who were exposed to the media content on the first device type;
estimating a second device type only reach using the second reach and the third reach, the second device type only reach comprising the number of users having access to only the second device type who were exposed to the media content on the second device type; and
estimating the total reach using the third reach, the first device type only reach, and the second device type only reach.

9. The method of claim 8, wherein the first reach associated with the users having access to the first device type and the one or more other device types is adjusted based on an assumption of invariance across the plurality of panel universes.

10. The method of claim 9, wherein the adjustment is by population difference between panel weightings and a population benchmark.

11. The method of claim 8, wherein the second reach associated with the users having access to the second device type and the one or more other device types is adjusted based on an assumption of invariance across the plurality of panel universes.

12. The method of claim 11, wherein the adjustment is by population difference between panel weightings and a population benchmark.

13. The method of claim 8, wherein a joint reach of the first reach and the second reach is invariant across the plurality of panel universes.

14. The method of claim 8, further comprising compensating for a difference between populations of the plurality of panel universes by applying a scaling factor.

15. A method of calculating a total reach of a media item, the total reach indicating a total number of user exposures to the media item, using a plurality of panel universes, executed on a computing device, the method comprising:
receiving a first data set from a cross media panel indicative of a number of times the media item was exposed to users having access to a plurality of device types, the users being exposed to the media item on at least one of the plurality of device types;
determining a first reach using the first data set;
receiving a second data set from a first device type marginal panel indicative of a number of times the media item was consumed by users on a first device type of the plurality of device types;
determining a second reach associated with the first device type from the second data set;
receiving a third data set from a second device type marginal panel indicative of a number of times the media item was consumed by users on a second device type of the plurality of device types;
determining a third reach associated with the second device type from the third data set;
estimating a first device type only reach using the first reach and the second reach associated with the first device type, the first device type only reach comprising the number of users having access to only the first device type of the plurality of device types who were exposed to the media content on the first device type;
estimating a second device type only reach using the first reach and the third reach associated with the second device type, the second device type only reach comprising the number of users having access to only the second device type of the plurality of device types who were exposed to the media content on the second device type; and
estimating the total reach using the first reach, the first device type only reach, and the second device type only reach.

16. The method of claim 15, wherein the second reach associated with the users having access to the first device type is adjusted based on an assumption of invariance across the plurality of panel universes.

17. The method of claim 16, wherein the adjustment is by population difference between panel weightings and a population benchmark.

18. The method of claim 15, wherein the third reach associated with the users having access to the second device type is adjusted based on an assumption of invariance across the plurality of panel universes.

19. The method of claim 18, wherein the adjustment is by population difference between panel weightings and a population benchmark.

20. The method of claim 15, further comprising compensating for a difference between populations of the plurality of panel universes by applying a scaling factor.
